(19) United States
(12) Patent Application Publication
(10) Pub. No.: US 2017/0135073 A1
(43) Pub. Date: May 11, 2017

(54) Hybrid Automatic Repeat Request for Enhanced Interference Management and Traffic Adaptation

(71) Applicant: Nokia Solutions and Networks Oy, Espoo (FI)

(72) Inventors: Esa Tapani TIIROLA, Kempele (FI); Timo Erkki LUNTTILA, Espoo (FI)

(21) Appl. No.: 15/317,503

(22) PCT Filed: Jun. 13, 2014
(86) PCT No.: PCT/EP2014/062459

§ 371 Date: Dec. 9, 2016

(51) Int. Cl. H04W 72/04; H04W 8/06; H04L 1/08; H04W 4/06; H04L 1/18; H04L 5/14; H04W 72/12

(52) U.S. Cl. CPC H04W 72/042; H04L 5/14; H04W 8/06; H04W 72/1268; H04W 4/06; H04L 1/1816; H04L 1/1896; H04L 1/08; H04L 1/1893

(57) ABSTRACT

Various communication systems, such as the long tem evolution advanced (LTE-Advanced) system, may benefit from different configurations for time division duplex (TDD). For example, LTE-Advanced systems may benefit from an enhanced dynamic TDD feature, which may—among other things—reduce latency for LTE-TDD, for example when enhanced interference management and traffic adaptation (eIMTA) is applied. A method can include broadcasting a time division duplex uplink-downlink configuration for a user equipment. The method can also include configuring, via dedicated radio resource control signaling, a downlink hybrid automatic repeat request uplink-downlink reference configuration to a user equipment. The method can further include configuring to the user equipment that at least one new or additional time division duplex uplink-downlink configuration is in use in enhanced operation for a category of user equipment.

### BACKGROUND

Field:

Various communication systems, such as the long term evolution advanced (LTE-Advanced) system, may benefit from different configurations for time division duplex (TDD). For example, LTE-Advanced systems may benefit from an enhanced dynamic TDD feature, which may—among other things—reduce latency for LTE-TDD, for example when enhanced interference management and traffic adaptation (eIMTA) is applied.

Description of the Related Art:

“Further Enhancements to LTE TDD for DL-UL Interference Management and Traffic Adaptation” is a work item (WI) related to eIMTA, and is described at third generation partnership project (3GPP) RP-121772, which is hereby incorporated herein by reference in its entirety. The WI may relate to flexible TDD uplink-downlink (UL-DL) reconfiguration for traffic adaptation in, for example, small cells, depending on the ratio of uplink and downlink traffic. The starting point may be that for those user equipment (UEs) configured with flexible UL/DL mode, the eNB may vary UL-DL configuration relatively often compared to the existing (Rel-11) situation where UL-DL configuration is in practice very static.

The basic conventional assumptions for eIMTA functionality include that there is a predefined cell-specific UL-DL configuration broadcasted in the cell using system information block one (SIB1). The legacy UEs (Rel'8-Rel'11) in the cell are assumed to follow this configuration all the time. The assumptions also that no new TDD UL-DL configurations are introduced: thus, flexible TDD reconfiguration can only happen among the existing seven configurations.

A further conventional assumption is that TDD reconfiguration can occur with at most one radio frame, which is 10 ms, periodicity for those UEs configured with flexible TDD configuration. It is also conventionally assumed that in each UL-DL configuration there are fixed subframes where the link direction is always predetermined. These fixed subframes are denoted as D for downlink, S for special, and U for uplink. It is further assumed conventionally that there are also flexible subframes, denoted as F. Flexible subframes can be used as D or U.

FIG. 1 illustrates a radio frame showing downlink (D), uplink (U), and special (S) subframes according to exemplary SIB-1 configuration #0, as well as flexible subframes (F) available for Rel-12 UEs configured to flexible UL/DL mode. Thus, FIG. 1 illustrates a basic setting.

As shown in FIG. 1, TDD UL-DL configuration 0 is shown as an example, but the same principle applies to other configurations as well. In addition to the SIB1 configured UL-DL configuration, which defines whether a given subframe in the radio frame is downlink, special, or uplink subframe, in the case of flexible TDD UL-DL configurations e.g. some of the uplink subframes can be changed into downlink subframes. The number of flexible subframes depends on the scenario.

FIG. 2 illustrates TDD configurations (left) and configuration flexibility depending on UL and DL HARQ reference configurations (right). The flexibility shown in FIG. 2 can depend on SIB-1 defined TDD UL-DL configuration (defining the UL HARQ reference configuration), as well as defined DL HARQ reference configuration.

In LTE, both frequency division duplex (FDD) and TDD, UL HARQ operation is designed to be synchronous, which means that HARQ retransmissions of PUSCH transport blocks related to a certain HARQ process take place in predetermined subframes. In eIMTA, UL HARQ/scheduling timing follows the TDD configuration defined by the SIB1 configuration, namely the UL HARQ reference configuration.

FIG. 3 illustrates UL HARQ processes for UL-DL configurations #0 and #1. UL HARQ processes with TDD configurations #0 and #6 provide examples for the purposes of illustration. With those TDD configurations UL HARQ processes move from subframe-to-subframe, thus periodicity of the HARQ processes is not 10 ms. In particular, TDD configuration #0, as shown in FIG. 3, and configuration #6 have this property. HARQ processes have periodicity of 10 ms in TDD configurations #1-#5. This is illustrated in FIG. 3, in the example that covers TDD configuration #1.

FIG. 4 illustrates drifting UL HARQ timing with UL-DL configuration #0. The consequence of a drifting UL HARQ process is that pending HARQ retransmissions limit possibilities for utilizing DL heavy UL-DL configurations. This may negatively impact eIMTA gains. For example, if the pending retransmission relates to subframe #9, then the only option may be to select TDD configuration #0, UL heavy, even if the traffic need would require TDD configuration #5, DL heavy.

As shown in FIG. 4, an eNodeB sends the UL grant to the UE in subframe #1 of radio frame #0. Then, the UE transmits the corresponding PUSCH in UL subframe #8 of radio frame #0. However, the eNodeB fails to receive the PUSCH correctly and sends a NACK via PHICH in subframe #5 of radio frame #1. Accordingly, UE retransmits the PUSCH in subframe #9 of radio frame #5. This means that the eNodeB must select UL-DL configuration #0 also for radio frame #5.

FIG. 5 illustrates conventional configurations #0-#6. Due to the above described drifting HARQ timing, it may be impractical to utilize TDD UL-DL configurations #0 and #6 fully in eIMTA when there are any PUSCH retransmissions. Furthermore, TDD configurations #0 and #6 can be considered as the most relevant UL-DL configurations for eIMTA since they have the maximum UD-DL flexibility. This invention provides solutions for the above described problem.

FIG. 6 illustrates the latency for UL-HARQ retransmission. Rel-12 solution is based on an implementation based approach called HARQ-suspension, which increases UL latency. For example, when the eNB continuously allocates DL-heavy TDD-UL-DL configuration, TDD configuration #5, the UL HARQ retransmission latency becomes 70 ms, whereas the latency in for example FDD is just 8 ms.

### SUMMARY

According to certain embodiments, a method can include broadcasting via system information block one a time division duplex uplink-downlink configuration for a user equipment. The method can also include configuring, via dedicated radio resource control signaling, a time division duplex downlink hybrid automatic repeat request uplink-downlink reference configuration to a user equipment. The method can further include configuring to the user equipment that at least one new or additional time division duplex uplink-downlink configuration is in use in enhanced operation for a category of user equipment. The at least one new or additional time division duplex configuration can include at least one additional special subframe not located in subframes #1 or #6.

In certain embodiments, an apparatus can include means for broadcasting via system information block one a time division duplex uplink-downlink configuration for a user equipment. The apparatus can also include means for configuring, via dedicated radio resource control signaling, a time division duplex downlink hybrid automatic repeat request uplink-downlink reference configuration to a user equipment. The apparatus can further include means for configuring to the user equipment that at least one new or additional time division duplex uplink-downlink configuration is in use in enhanced operation for a category of user equipment. The at least one new or additional time division duplex configuration can include at least one additional special subframe not located in subframes #1 or #6.

An apparatus, in certain embodiments, can include at least one processor and at least one memory including computer program code. The at least one memory and the computer program code can be configured to, with the at least one processor, cause the apparatus at least to broadcast via system information block one a time division duplex uplink-downlink configuration for a user equipment. The at least one memory and the computer program code can also be configured to, with the at least one processor, cause the apparatus at least to configure, via dedicated radio resource control signaling, a time division duplex downlink hybrid automatic repeat request uplink-downlink reference configuration to a user equipment. The at least one memory and the computer program code can further be configured to, with the at least one processor, cause the apparatus at least to configure to the user equipment that at least one new or additional time division duplex uplink-downlink configuration is in use in enhanced operation for a category of user equipment. The at least one new or additional time division duplex configuration can include at least one additional special subframe not located in subframes #1 or #6.

A non-transitory computer-readable medium can, in certain embodiments, encode instructions that, when executed in hardware, perform a process. The process can include broadcasting via system information block one a time division duplex uplink-downlink configuration for a user equipment. The process can also include configuring, via dedicated radio resource control signaling, a time division duplex downlink hybrid automatic repeat request uplink-downlink reference configuration to a user equipment. The process can further include configuring to the user equipment that at least one new or additional time division duplex uplink-downlink configuration is in use in enhanced operation for a category of user equipment. The at least one new or additional time division duplex configuration can include at least one additional special subframe not located in subframes #1 or #6.

According to certain embodiments, a method can include receiving via system information block one a time division duplex uplink-downlink configuration for a user equipment. The method can also include receiving, via dedicated radio resource control signaling, a time division duplex downlink hybrid automatic repeat request uplink-downlink configuration from a base station. The method can further include receiving an indication that at least one new or additional time division duplex uplink-downlink configuration is in use in enhanced operation for a category of user equipment. The method can additionally include operating a user equipment according to the at least one new or additional time division duplex uplink-downlink configuration rather than according to the time division duplex uplink-downlink configuration #0-#6 when in enhanced operation. The at least one new or additional time division duplex configuration can include at least one additional special subframe not located in subframes #1 or #6.

In certain embodiments, an apparatus can include means for receiving via system information block one a time division duplex uplink-downlink configuration for a user equipment. The apparatus can also include means for receiving, via dedicated radio resource control signaling, a time division duplex downlink hybrid automatic repeat request uplink-downlink configuration from a base station. The apparatus can further include means for receiving an indication that at least one new or additional time division duplex uplink-downlink configuration is in use in enhanced operation for a category of user equipment. The apparatus can additionally include means for operating a user equipment according to the at least one new or additional time division duplex uplink-downlink configuration rather than according to the time division duplex uplink-downlink configuration #0-#6 when in enhanced operation. The at least one new or additional time division duplex configuration can include at least one additional special subframe not located in subframes #1 or #6.

An apparatus, in certain embodiments, can include at least one processor and at least one memory including computer program code. The at least one memory and the computer program code can be configured to, with the at least one processor, cause the apparatus at least to receive via system information block one a time division duplex uplink-downlink configuration for a user equipment. The at least one memory and the computer program code can also be configured to, with the at least one processor, cause the apparatus at least to receive, via dedicated radio resource control signaling, a time division duplex downlink hybrid automatic repeat request uplink-downlink configuration from a base station. The at least one memory and the computer program code can further be configured to, with the at least one processor, cause the apparatus at least to receive an indication that at least one new or additional time division duplex uplink-downlink configuration is in use in enhanced operation for a category of user equipment. The at least one memory and the computer program code can additionally be configured to, with the at least one processor, cause the apparatus at least to operate a user equipment according to the at least one new or additional time division duplex uplink-downlink configuration rather than according to the time division duplex uplink-downlink configuration #0-#6 when in enhanced operation. The at least one new or additional time division duplex configuration can include at least one additional special subframe not located in subframes #1 or #6.

A non-transitory computer-readable medium can, in certain embodiments, encode instructions that, when executed in hardware, perform a process. The process can include receiving via system information block one a time division duplex uplink-downlink configuration for a user equipment. The process can also include receiving, via dedicated radio resource control signaling, a time division duplex downlink hybrid automatic repeat request uplink-downlink configuration from a base station. The process can further include receiving an indication that at least one new or additional time division duplex uplink-downlink configuration is in use in enhanced operation for a category of user equipment. The process can additionally include operating a user equipment according to the at least one new or additional time division duplex uplink-downlink configuration rather than according to the time division duplex uplink-downlink configuration #0-#6 when in enhanced operation. The at least one new or additional time division duplex configuration can include at least one additional special subframe not located in subframes #1 or #6.

### BRIEF DESCRIPTION OF THE DRAWINGS

For proper understanding of the invention, reference should be made to the accompanying drawings, wherein:

FIG. 1 illustrates a radio frame showing various fixed subframes according to exemplary SIB-1 configuration #0, as well as flexible subframes (F).

FIG. 2 illustrates TDD configurations and configuration flexibility depending on UL and DL HARQ reference configurations.

FIG. 3 illustrates UL HARQ processes for UL-DL configurations #0 and #1.

FIG. 4 illustrates drifting UL HARQ timing with UL-DL configuration #0.

FIG. 5 illustrates conventional configurations #0-#6.

FIG. 6 illustrates the latency for UL-HARQ retransmission.

FIG. 7 illustrates four exemplary TDD uplink-downlink configurations according to certain embodiments.

FIG. 8 illustrates two subframes for Sₐ in a configuration according to certain embodiments.

FIG. 9 illustrates a method according to certain embodiments.

FIG. 10 illustrates a coexistence scheduling restriction according to certain embodiments.

FIG. 11 illustrates TDD configuration mappings by indicator, according to certain embodiments.

FIG. 12 illustrates Table 1, a downlink association set index for TDD, according to certain embodiments.

FIG. 13 illustrates Table 2, a downlink association set indexing for latency optimized subconfiguration, according to certain embodiments.

FIG. 14 illustrates a system according to certain embodiments.

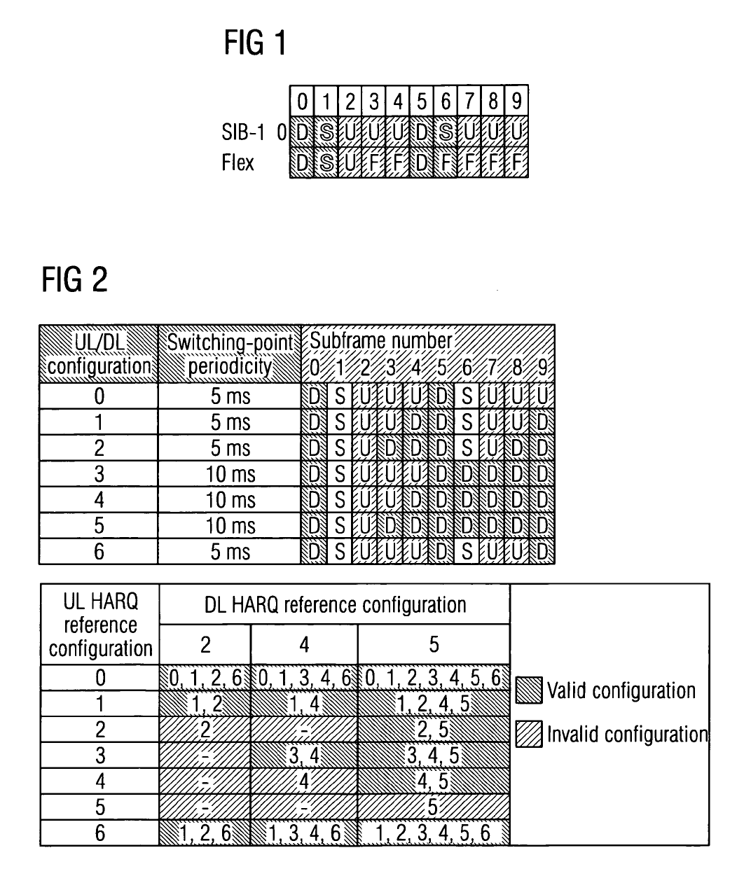

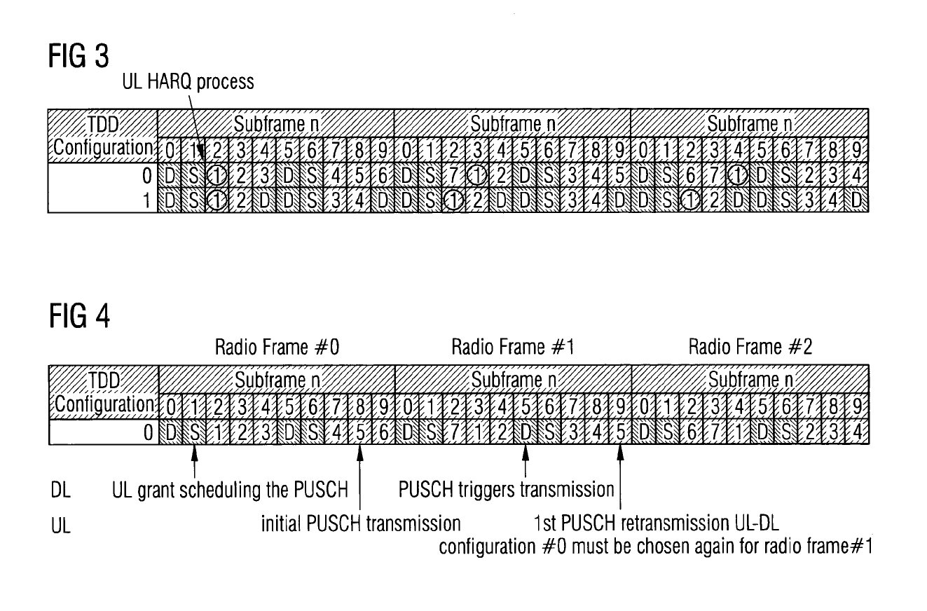

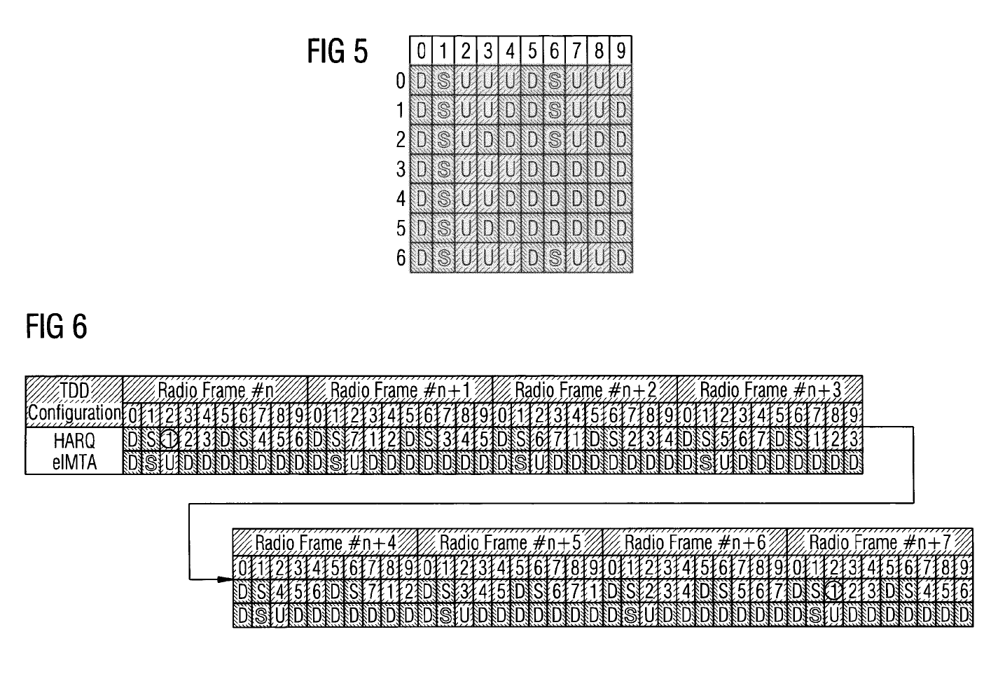

### DETAILED DESCRIPTION

Certain embodiments define new TDD UL-DL configurations that have additional UL-DL switching points, or special subframes, within the radio frame. More specifically, at least one new TDD uplink-downlink configuration for eIMTA is provided in certain embodiments. Furthermore, certain embodiments demonstrate and illustrate how such an uplink-downlink configuration can be operated in combination with eIMTA.

In certain embodiments, a TDD UL-DL configuration can have subframe that is a predetermined UL subframe according to SIB1 configuration or UL reference configuration, denoted as n, but which is used as an additional special subframe (Sₐ).

For example, in certain embodiments, one of the existing TDD uplink-downlink configurations can be used as a mother configuration when defining the new TDD uplink-downlink configuration. The mother configuration can define the subframe types (D/S/U) in the absence of additional special subframes. Furthermore, the mother configuration can be part of the candidate TDD uplink-downlink configuration set defined for eIMTA (See FIG. 2) according to Rel-12 principles. This may permit the new TDD uplink-downlink configuration to be compatible with the previous generation eIMTA framework. For example, TDD uplink-downlink configuration #5 can be used as the mother configuration.

The position of an additional special subframe (Sₐ) can be expressed in terms of the subframe number within the radio frame. Furthermore, one or more UL subframes, which can be denoted n+1, n+2, and so on, following Sₐ can be used as additional UL subframes, compared to the mother configuration. Alternatively, it is also possible to define that one or more UL subframes, again denoted n+1, n+2, and so on, following Sₐ can be used as DL subframes. In certain embodiments, there can be just a special subframe comprising Downlink Pilot Time Slot (DwPTS), Guard Period (GP), and Uplink Pilot Time Slot (UpPTS) followed by DL subframes without any UL subframes, in the new TDD uplink-downlink configuration.

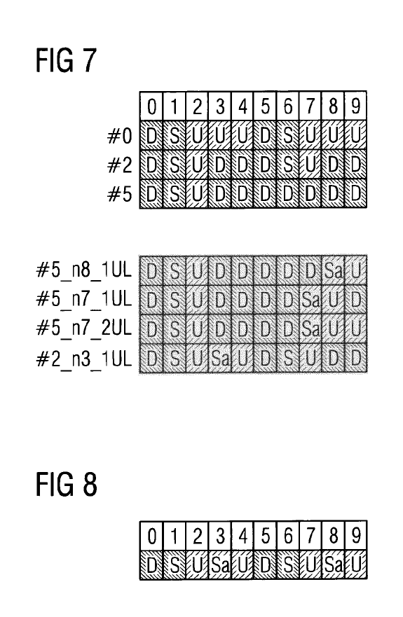

FIG. 7 illustrates four exemplary TDD uplink-downlink configurations according to certain embodiments. In FIG. 7, these configurations are denoted as #mother_n_#UL, in which #mother is the mother configuration or the UL-DL configuration that is used as a basis for the new configuration, n is the subframe index of a special subframe, and #UL is the number of UL subframes following Sₐ. These examples assume that TDD configuration defined by SIB1 is configuration #0, although the same approach can be applied to the other configurations.

FIG. 8 illustrates two subframes for Sₐ in a configuration according to certain embodiments. Certain embodiments can provide a way to define a latency optimized TDD configuration. An example of such arrangement may be seen in example #0_n(3,8), shown in FIG. 8. In this example, there are two subframes each defined as Sₐ for a radio frame of 10 subframes. Thus, DL to UL to DL switching can be made four times per radio frame.

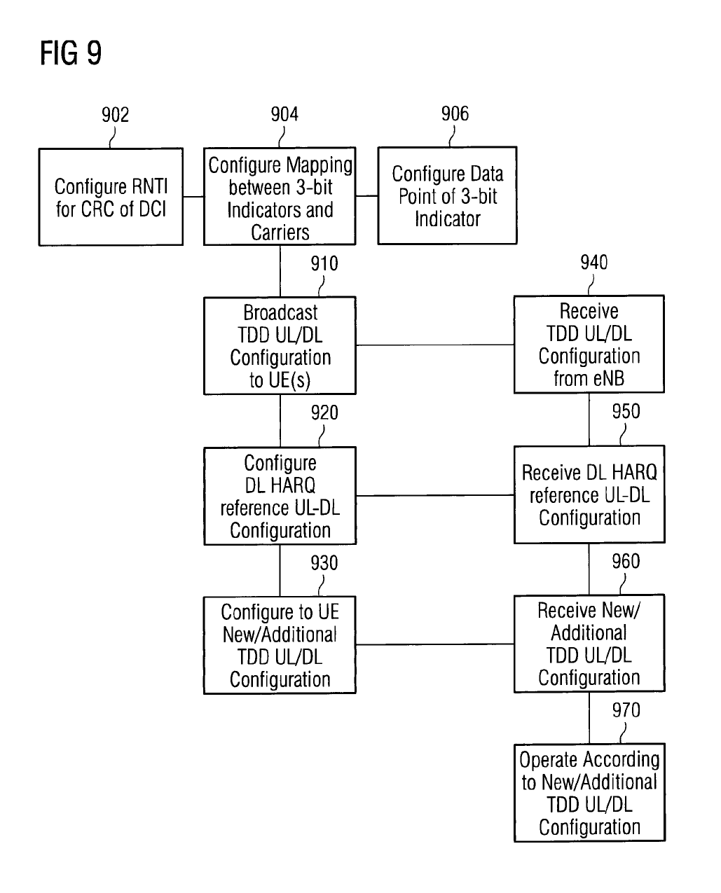

Certain embodiments may be implemented in various ways, of which the following are a few non-limiting examples. For example, FIG. 9 illustrates a method according to certain embodiments. As shown in FIG. 9, at 910 a method can include broadcasting via system information block one a time division duplex uplink-downlink configuration for a user equipment. UEs of all categories may need to receive this, but certain UEs, such as rel-8 UEs, may receive this configuration only. UEs of other categories may receive additional configuration. For example, an eNodeB can broadcast one TDD UL-DL configuration to the UE via SIB-1. This broadcast configuration can be the UL-DL configuration that, for example, Rel-8 UEs can use.

Furthermore, at 920 the method can include configuring, via dedicated radio resource control signaling, a time division duplex downlink hybrid automatic repeat request uplink-downlink reference configuration to a user equipment. For example, the eNodeB can configure to the UE, for example via dedicated RRC signaling, the DL HARQ reference UL-DL configuration, which may be similar to or the same as that used for LTE Rel-12 eIMTA operation. This UL-DL configuration can determine the DL HARQ timing among other parameters, such as, for example, the HARQ-ACK codebook size.

Additionally, at 930 the method can include configuring to the user equipment that at least one new or additional time division duplex uplink-downlink configuration (compared to those defined in LTE Rel-8 and applied also in LTE Rel-12 eIMTA) is in use in enhanced operation for a category of user equipment. For example, the eNodeB can indicate to the UE that new additional TDD UL-DL configuration(s) are in use in eIMTA operation. This configuring can be done via dedicated RRC signaling.

There could, in principle, be three categories of UEs. According to a first category, there can be Rel-8 UEs, which may only get the SIB-1 configuration. According to a second category, there can be the Rel-12 eIMTA UEs, which also get the DL reference HARQ configuration, in addition to SIB-1. Furthermore, according to a third category, there can be UEs according to certain embodiments, receiving SIB-1 configuration, DL HARQ configuration and a new/additional configuration.

A new configuration can include at least one additional special subframe not located in subframes #1 or #6—namely not located in either or both of those subframes. In certain embodiments, this configuration can determine the UL HARQ timing instead of the SIB-1 signaled UL-DL configuration and can be a latency optimized configuration, as described herein.

Furthermore, at 902, the method can include configuring to the user equipment a radio network temporary identifier used for scrambling a cyclic redundancy check of a downlink control information carrying the at least one new or additional time division duplex uplink-downlink configuration. Also, the method can include, at 904, configuring to the user equipment a mapping between e.g. three-bit indicators carrying the uplink-downlink configuration and the corresponding carriers. Indicators of other bit-lengths are also permitted. For example, the eNodeB can indicate to the UE the RNTI that is used for scrambling the CRC of the DCI carrying the dynamically signaled UL-DL configuration, as well as the mapping between the 3-bit indicators carrying the UL-DL configuration, and the corresponding carriers.

Additionally, at 906, the method can include configuring a data point of the three-bit indicator to indicate that the at least one new or additional time division duplex configuration is to be used. For example, the eNodeB may configure one of the data points of a 3-bit indicator to indicate a new additional TDD UL-DL configuration is to be used.

The method of FIG. 9 can also include, at 940, receiving via system information block one a time division duplex uplink-downlink configuration for a user equipment. The method can also include, at 950, receiving, via dedicated radio resource control signaling, a time division duplex downlink hybrid automatic repeat request uplink-downlink configuration from a base station. The method can further include, at 960, receiving an indication that at least one new or additional time division duplex uplink-downlink configuration is in use in enhanced operation for a category of user equipment. The method can additionally include, at 970, operating a user equipment according to the at least one new or additional time division duplex uplink-downlink configuration rather than according to the time division duplex uplink-downlink configuration #0-#6 when in enhanced operation.

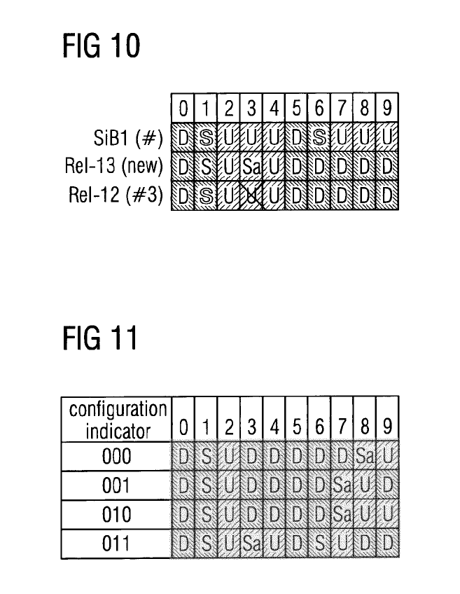

FIG. 10 illustrates a coexistence scheduling restriction according to certain embodiments. This figure illustrates signalling and coexistence with Rel-12 eIMTA.

Rel-13 operation can be triggered using an UL/DL reconfiguration indicator with a new RNTI. Also, there can be another parallel RNTI defined for Rel-12 eIMTA operation. Further, if the case eNB triggers Rel-13 operation, it may transmit only UUDL reconfiguration indicator with a new RNTI. In this case legacy UEs can operate according to fallback mode, for example according to TDD configuration defined by SIB1.

Depending on the actual configurations, it is possible that both Rel-12 eIMTA and Rel-13 eIMTA can be triggered at the same time. In such a case, Rel-13 UEs operate according to an UL/DL reconfiguration indicator with Rel-13 RNTI. Furthermore, Rel-12 UEs can operate according to an UL/DL reconfiguration indicator with Rel-12 RNTI.

Moreover, an eNB can ensure that the eNB does not have UL reception for Rel-12 UEs, or legacy eIMTA, at the time the eNB is required to have DL transmission for Rel-13 UEs. For that reason, some scheduling restrictions may take place as shown in FIG. 10.

FIG. 11 illustrates TDD configuration mappings by indicator, according to certain embodiments. As shown in FIG. 11, supported new TDD configuration options can be configured via higher layer signaling. Each configured TDD configuration can be mapped into a predefined indicator field, for example, ‘000’. HARQ/scheduling timing can be based on UL and DL HARQ reference configurations according to Rel-12 eIMTA operation also in the case when the UE is configured to operate according to new or additional TDD UL-DL configurations.

Latency optimized configuration can be done in a variety of ways. In the current specification up to Release-11, the HARQ-ACK resource is implicitly determined from the corresponding physical resource indices. For example, the first CCE/ECCE index of PDCCH/EPDCCH is used to determine the DL HARQ-ACK resource, along with index of the DL subframe and the index of the OFDM symbol carrying the CCE/ECCE and some higher layer configured parameters.

One issue in PUCCH format 1a/1b resource allocation for TDD may be that more than one DL subframe may be associated with a single UL subframe.

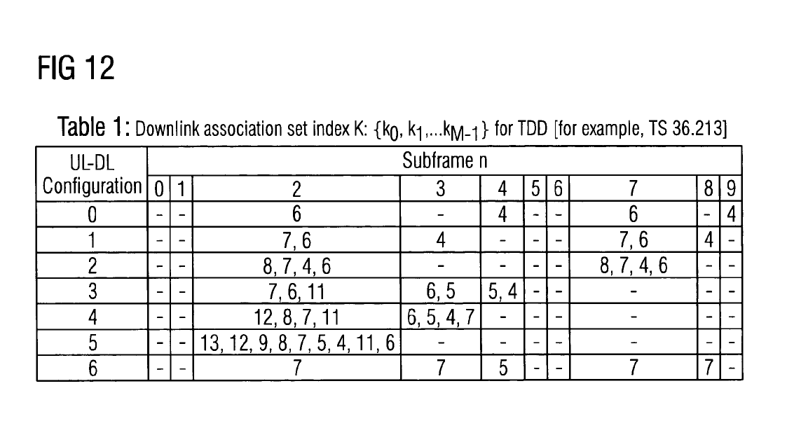

FIG. 12 illustrates Table 1, a downlink association set index for TDD, according to certain embodiments. As shown in Table 1, the HARQ-ACKs corresponding to M, which could be 1, 2, 3, 4, DL subframes can be reported in one UL subframe. The UE can use a PUCCH resource in subframe n, where PDSCH transmission can be indicated by the detection of corresponding PDCCH or PDCCH indicating downlink SPS release within subframe(s) n-k, where kεK.

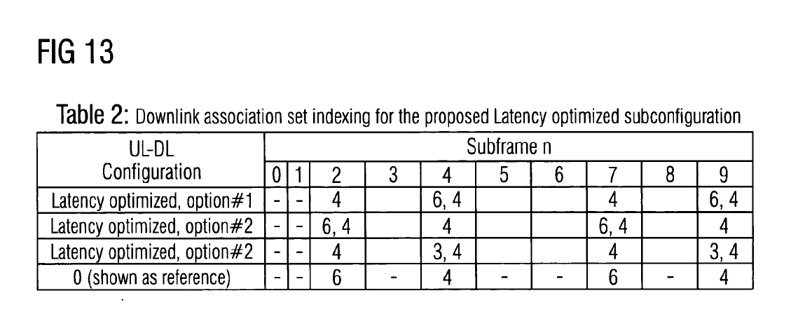

FIG. 13 illustrates Table 2, a downlink association set indexing for latency optimized subconfiguration, according to certain embodiments. Latency optimized configuration may utilize a new timing relationship at least for HARQ-ACK. Table 2 provides three options for HARQ-timing, based on latency optimized configuration discussed above. Similar timing optimization can be made for other functionalities, for example PUSCH-to-PHICH timing or DCI/PHICH-to-PUSCH timing.

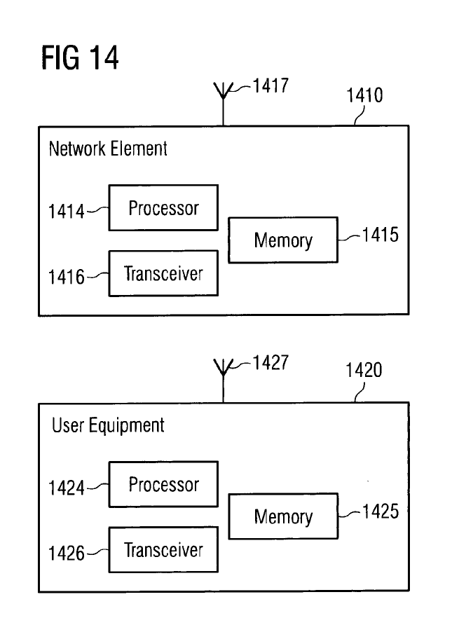

FIG. 14 illustrates a system according to certain embodiments of the invention. It should be understood that each block of the flowchart of FIG. 9 and any combination thereof may be implemented by various means or their combinations, such as hardware, software, firmware, one or more processors and/or circuitry. In one embodiment, a system may include several devices, such as, for example, network element 1410 and user equipment (UE) or user device 1420. The system may include more than one UE 1420 and more than one network element 1410, although only one of each is shown for the purposes of illustration. A network element can be an access point, a base station, an eNode B (eNB), server, host or any of the other network elements discussed herein. Each of these devices may include at least one processor or control unit or module, respectively indicated as 1414 and 1424. At least one memory may be provided in each device, and indicated as 1415 and 1425, respectively. The memory may include computer program instructions or computer code contained therein. One or more transceiver 1416 and 1426 may be provided, and each device may also include an antenna, respectively illustrated as 1417 and 1427. Although only one antenna each is shown, many antennas and multiple antenna elements may be provided to each of the devices. Other configurations of these devices, for example, may be provided. For example, network element 1410 and UE 1420 may be additionally configured for wired communication, in addition to wireless communication, and in such a case antennas 1417 and 1427 may illustrate any form of communication hardware, without being limited to merely an antenna. Likewise, some network elements 1410 may be solely configured for wired communication, and such cases antenna 1417 may illustrate any form of wired communication hardware, such as a network interface card.

Transceivers 1416 and 1426 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is as software that can run on a server.

A user device or user equipment 1420 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. The user device or user equipment 1420 may be a sensor or smart meter, or other device that may usually be configured for a single location.

In an exemplary embodiment, an apparatus, such as a node or user device, may include means for carrying out embodiments described above in relation to FIG. 9 or any of the other figures.

Processors 1414 and 1424 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (e.g., procedures, functions, and so on). Memories 1415 and 1425 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 1410 and/or UE 1420, to perform any of the processes described above (see, for example, FIG. 9). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 14 illustrates a system including a network element 1410 and a UE 1420, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments may address the UL HARQ issue, discussed above, related to TDD configurations #0 and #6. Furthermore, certain embodiments can coexist with both legacy UEs and Rel-12 eIMTA UEs. Furthermore, certain embodiments can allow maintenance of synchronous HARQ in UL. This can, in turn, minimize the implementation changes, for example compared to asynchronous UL. Additionally, certain embodiments can provide latency optimization for TD-LTE based, for example, on eIMTA framework.

An alternative to the above, may be asynchronous HARQ in UL. Asynchronous HARQ in UL, on the other hand, may require change of HARQ/scheduling timing. Furthermore, additional bits may be required in UL scheduling grants, for example a HARQ process number. Also, in such an approach PHICH-triggered retransmission may not be able to be applied anymore. Furthermore, such an approach might have an impact on the UE/eNB processing times.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

Partial Glossary

3GPP Third Generation Partnership Program

A/N ACK/NACK

ACK Acknowledgement

CCE Control Channel Element

D Downlink

DCI Downlink Control Information

DL Downlink

ECCE Enhanced CCE

eIMTA Enhanced Interference Management and Traffic Adaptation

eNB Enhanced Node B

EPDCCH Enhanced PDCCH

HARQ Hybrid Automatic Repeat request

LTE Long Term Evolution

NACK Negative ACK

OFDM Orthogonal Frequency Division Multiplex

PDCCH Physical Downlink Control Channel

PDSCH Physical Downlink Shared Channel

PHICH Physical HARQ Indicator Channel

PUCCH Physical Uplink Control Channel

PUSCH Physical Uplink Shared Channel

RAN Radio Access Network

Rel Release

RRC Radio Resource Control

S Special subframe

SF Subframe

SIB System Information Block

TDD Time Division Duplexing

U Uplink

UE User Equipment

UL Uplink

WG Working Group

1. A method, comprising:
broadcasting via system information block one a first time division duplex uplink-downlink configuration for a user equipment;
configuring, via dedicated radio resource control signaling, a time division duplex downlink hybrid automatic repeat request uplink-downlink reference configuration to a user equipment; and
configuring to the user equipment that at least one new or additional time division duplex uplink-downlink configuration is in use in enhanced operation for a category of user equipment
wherein the at least one new or additional time division duplex configuration comprises at least one additional special subframe not located in subframes #1 or #6.

2. The method of claim 1, wherein the enhanced operation comprises eIMTA operation.

3. The method of claim 1, wherein the configuring that the at least one new or additional time division duplex uplink-downlink configuration is in use is performed using dedicated radio resource control signaling.

4. The method of claim 1, wherein the at least one new or additional time division duplex uplink-downlink configuration utilizes the first TDD UL-DL configuration for UL HARQ timing and configured DL HARQ TDD UL-DL reference configuration for DL HARQ timing.

5. The method of claim 1, wherein the at least one new or additional time division duplex uplink-downlink configuration utilizes a new UL HARQ and UL scheduling timing and configured DL HARQ TDD UL-DL reference configuration for DL HARQ timing.

6. The method of claim 1, further comprising:
configuring to the user equipment a radio network temporary identifier used for scrambling a cyclic redundancy check of a downlink control information carrying the at least one new or additional time division duplex configuration.

7. The method of claim 6, further comprising:
configuring to the user equipment a mapping between indicators carrying the uplink-downlink configuration and the corresponding carriers and configuring a data point of the indicators to indicate that the at least one new or additional time division duplex configuration is to be used.

8. (canceled)

9. The method of any of claim 1, further comprising:
indicating to the user equipment a new or an additional time division duplex uplink-downlink configuration to be used using a downlink control information with a cyclic redundancy check scrambled with said radio network temporary identifier.

10. The method of claim 1, wherein the at least one new or additional time division duplex configuration is composed from a mother configuration selected from configuration #0-#6, wherein the mother configuration comprises a valid time division duplex uplink-downlink configuration with a given combination of uplink hybrid automatic repeat request reference configuration and downlink hybrid automatic repeat request reference configuration.

11. (canceled)

12. The method of claim 1, wherein at least one additional subframe consecutively following the at least one additional special subframe is used as an uplink subframe compared to a mother configuration.

13. The method of claim 1, wherein at least one additional subframe consecutively following the at least one additional special subframe is used as a downlink subframe compared to a mother configuration.

14. A method, comprising:
receiving via system information block one a time division duplex uplink-downlink configuration for a user equipment;
receiving, via dedicated radio resource control signaling, a time division duplex downlink hybrid automatic repeat request uplink-downlink configuration from a base station;
receiving an indication that at least one new or additional time division duplex uplink-downlink configuration is in use in enhanced operation for a category of user equipment; wherein the at least one new or additional time division duplex configuration comprises at least one additional special subframe not located in subframes #1 or #6; and
operating a user equipment according to the at least one new or additional time division duplex configuration rather than according to the time division duplex uplink-downlink configuration #0-#6 when in enhanced operation.

15. An apparatus, comprising:
at least one processor; and
at least one memory including computer program code,
wherein the at least one memory and computer program code are configured to, with the at least one processor, cause the apparatus at least to
broadcast via system information block one a first time division duplex uplink-downlink configuration for a user equipment;
configure, via dedicated radio resource control signaling, a time division duplex downlink hybrid automatic repeat request uplink-downlink reference configuration to a user equipment; and
configure to the user equipment that at least one new or additional time division duplex uplink-downlink configuration is in use in enhanced operation for a category of user equipment
wherein the at least one new or additional time division duplex configuration comprises at least one additional special subframe not located in subframes #1 or #6.

16. (canceled)

17. (canceled)

18. (canceled)

19. The apparatus of claim 15, wherein the at least one new or additional time division duplex uplink-downlink configuration utilizes a new UL HARQ and UL scheduling timing and configured DL HARQ TDD UL-DL reference configuration for DL HARQ timing.

20. (canceled)

21. (canceled)

22. The apparatus of claim 19, wherein the at least one memory and computer program code are configured to, with the at least one processor, cause the apparatus at least to configure a data point of the indicators to indicate that the at least one new or additional time division duplex configuration is to be used.

23. (canceled)

24. The apparatus of claim 15, wherein the at least one new or additional time division duplex configuration is composed from a mother configuration selected from configuration #0-#6 and wherein the mother configuration comprises a valid time division duplex uplink-downlink configuration with a given combination of uplink hybrid automatic repeat request reference configuration and downlink hybrid automatic repeat request reference configuration.

25. (canceled)

26. The apparatus of claim 15, wherein the at least one memory and computer program code are configured to, with the at least one processor, cause the apparatus at least to use at least one additional subframe, consecutively following the at least one additional special subframe, as an uplink subframe compared to a mother configuration.

27. The apparatus of claim 15, wherein the at least one memory and computer program code are configured to, with the at least one processor, cause the apparatus at least to use at least one additional subframe, consecutively following the at least one additional special subframe, as a downlink subframe compared to a mother configuration.

28. An apparatus, comprising:
at least one processor; and
at least one memory including computer program code,
wherein the at least one memory and computer program code are configured to, with the at least one processor, cause the apparatus at least to
receive via system information block one a time division duplex uplink-downlink configuration for a user equipment;
receive, via dedicated radio resource control signaling, a time division duplex downlink hybrid automatic repeat request uplink-downlink configuration from a base station;
receive an indication that at least one new or additional time division duplex uplink-downlink configuration is in use in enhanced operation for a category of user equipment; wherein the at least one new or additional time division duplex configuration comprises at least one additional special subframe not located in subframes #1 or #6; and
operate a user equipment according to the at least one new or additional time division duplex configuration rather than according to the time division duplex uplink-downlink configuration #0-#6 when in enhanced operation.

29-43. (canceled)

44. A non-transitory computer-readable medium encoded with instructions that, when executed in hardware, perform a process, the process comprising the method according to claim 1.
